(19) United States
(12) Patent Application Publication
(10) Pub. No.: US 2014/0009606 A1
(43) Pub. Date: Jan. 9, 2014

(54) Head Mounted Rearview Camera System

(71) Applicant: Serge Puccio, Tomball, TX (US)

(72) Inventor: Serge Puccio, Tomball, TX (US)

(21) Appl. No.: 13/544,641

(22) Filed: Jul. 9, 2012

(51) Int. Cl. H04N 7/18

(52) U.S. Cl. 348/143; 348/E07.085

(57) ABSTRACT

A head mounted rearview camera system that includes a reversible image camera having an image converter to enantiomorphically render a rearward field-of-view to a display, said display integral to a pair of video glasses, wherein an image of a rearward field-of-view is projected to at least one of a pair of lenses of the video glasses and the rearward field-of-view is thereby maintained spatially oriented and sensible relative the spatial orientation of the user.

### BACKGROUND OF THE INVENTION

Various types of head mounted rearview camera systems are known in the prior art. However, what is needed is a head mounted rearview camera system that includes a reversible image camera having an image converter to enantiomorphically render a rearward field-of-view to a display, said display integral to a pair of video glasses, wherein an image of a rearward field-of-view is displayed on at least one of a pair of lenses of said video glasses and the rearward field-of-view is maintained spatially oriented and sensible relative the spatial orientation of the user.

### FIELD OF THE INVENTION

The present invention relates to a head mounted rearview camera system, and more particularly, to a head mounted rearview camera system that includes a reversible image camera having an image converter to enantiomorphically render a rearward field-of-view to a display, said display integral to a pair of video glasses, wherein an image of a rearward field-of-view is displayed on at least one of a pair of lenses of said video glasses and the rearward field-of-view is maintained spatially oriented and sensible relative the spatial orientation of the user.

### SUMMARY OF THE INVENTION

The general purpose of the head mounted rearview camera system, described subsequently in greater detail, is to provide a head mounted rearview camera system which has many novel features that result in a head mounted rearview camera system which is not anticipated, rendered obvious, suggested, or even implied by prior art, either alone or in combination thereof.

The present invention has been devised to enable a user to see a rearward field-of-view oriented spatially appropriate to said user. If a normal camera is mounted rearwardly with respect to a user, the field-of-view is reversed relative the user, and an object portrayed on a user's right side, say, is actually relative a user's left side. Enantiomorphically rendering the rearward field-of-view, however, maintains the correct spatial relationship of objects in a rearward field-of-view relative a user.

The present device, therefore, includes a reversible field-of-view camera disposed to capture images rearwardly relative a user, and display these images enantiomorphically upon a pair of video glasses worn by the user. The reversible field-of-view camera includes an image converter to render the field-of-view enantiomorphically, and a user can, when using the device, walk or run backwards without fear of walking into objects and structures. As such the present device is useful for exercising leg muscles, deterring muscle memory and increasing user coordination by enabling a person wearing the device to walk and run backwards.

The camera is mountable to a headband, the camera in operational communication with a display integral to the pair of video glasses. The display displays video captured by the camera, enantiomorphically rendered by the image converter, upon at least one of a pair of lenses disposed on the video glasses. The user is then able to see a rearward field-of-view correctly oriented with respect to the user: objects appearing on a user's left side, for example, will be on the left side of the user.

In the preferred embodiment herein disclosed, the display is disposed upon at ii least one of the pair of lenses. Thusly, a user is enabled to see the images proximal to one eye, and, while using the device, remain sensible of a rearward field-of-view without turning the head, or turning around.

In the preferred embodiment herein disclosed a battery pack is disposed within the headband, the battery pack powering the camera including the image converter, and the display. A cable connects the display to the battery pack and camera including the image converter. The intended spirit and scope of the invention includes a reversible image camera, and alternately a camera in operational communication with an image converter disposed separate from the camera within the headband.

Thus has been broadly outlined the more important features of the present head mounted rearview camera system so that the detailed description thereof that follows may be better understood and in order that the present contribution to the art may be better appreciated.

Objects of the present head mounted rearview camera system, along with various novel features that characterize the invention are particularly pointed out in the claims forming a part of this disclosure. For better understanding of the head mounted rearview camera system, its operating advantages and specific objects attained by its uses, refer to the accompanying drawings and description.

### BRIEF DESCRIPTION OF THE DRAWINGS

Figures

FIG. 1 is an isometric view.

FIG. 2 is a back view.

FIG. 3 is a top view.

FIG. 4 is a detail view taken along the line 4-4 of FIG. 3.

FIG. 5 is an in-use view.

FIG. 6 is a schematic view.

### DETAILED DESCRIPTION OF THE DRAWINGS

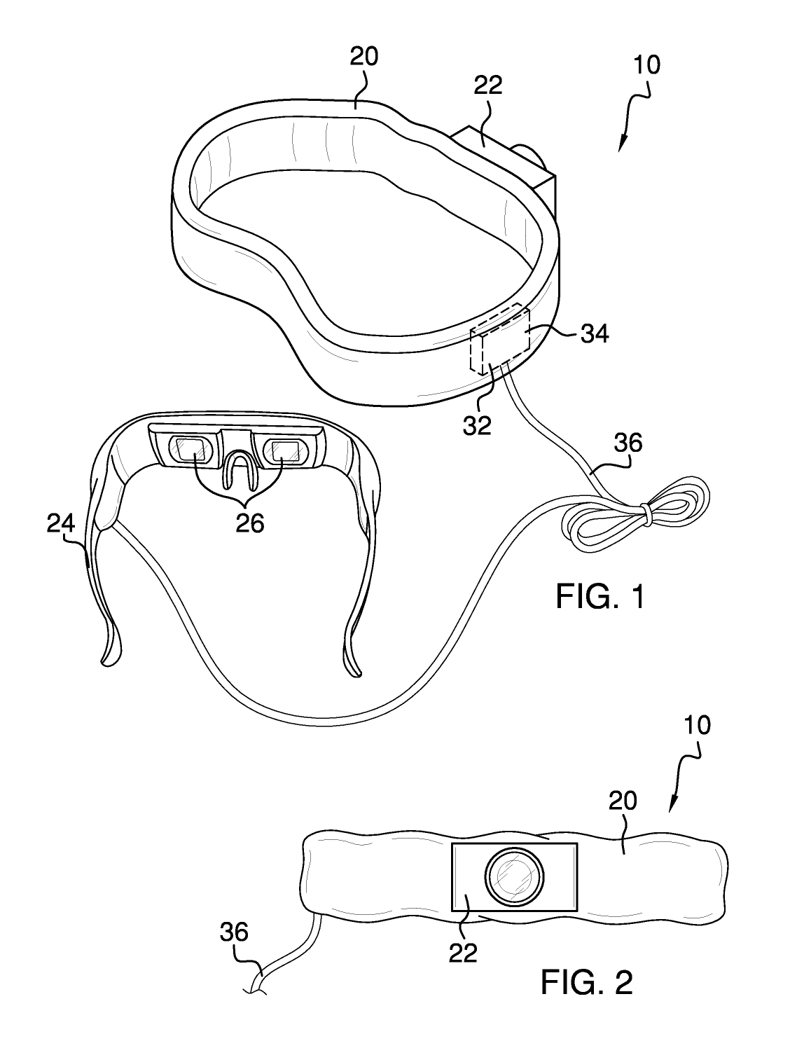

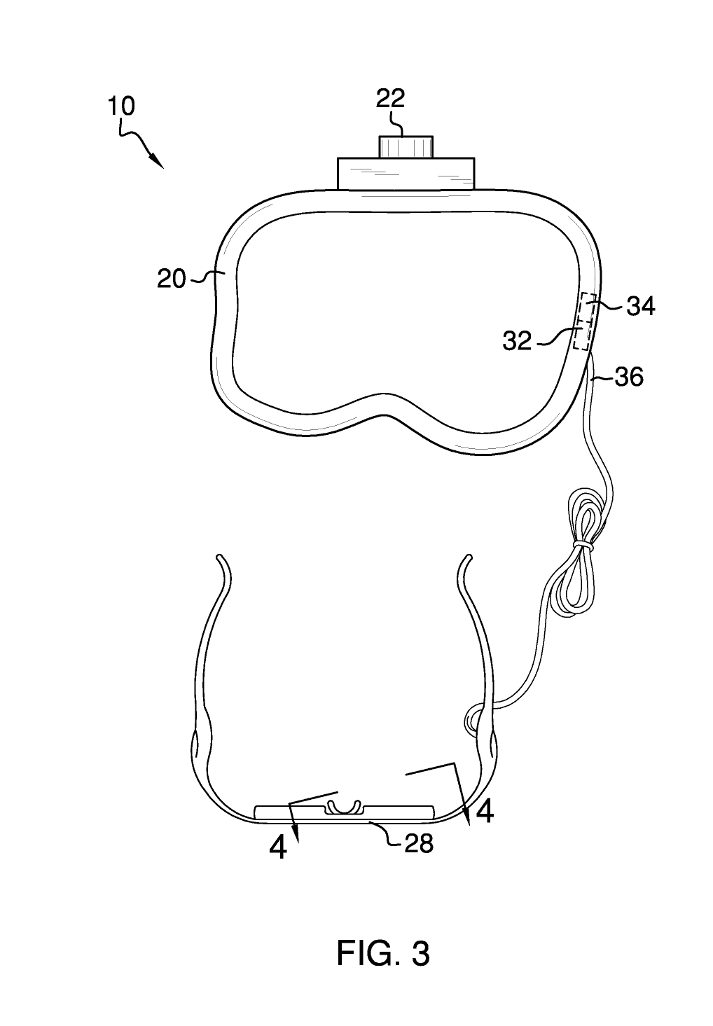

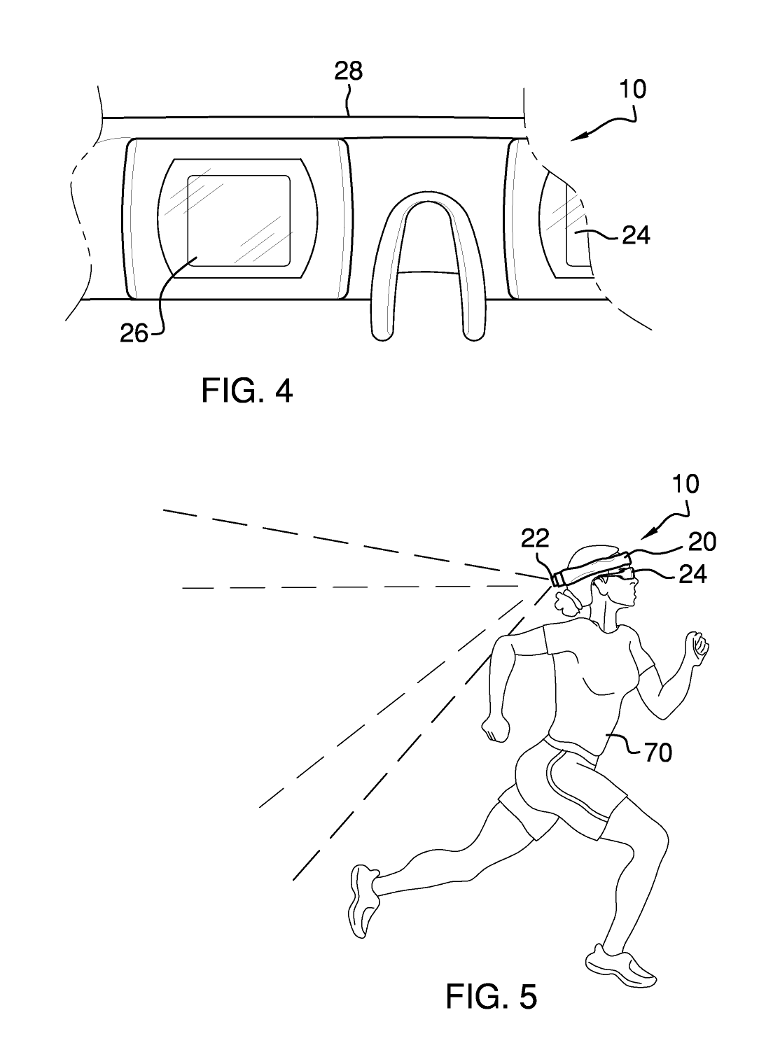

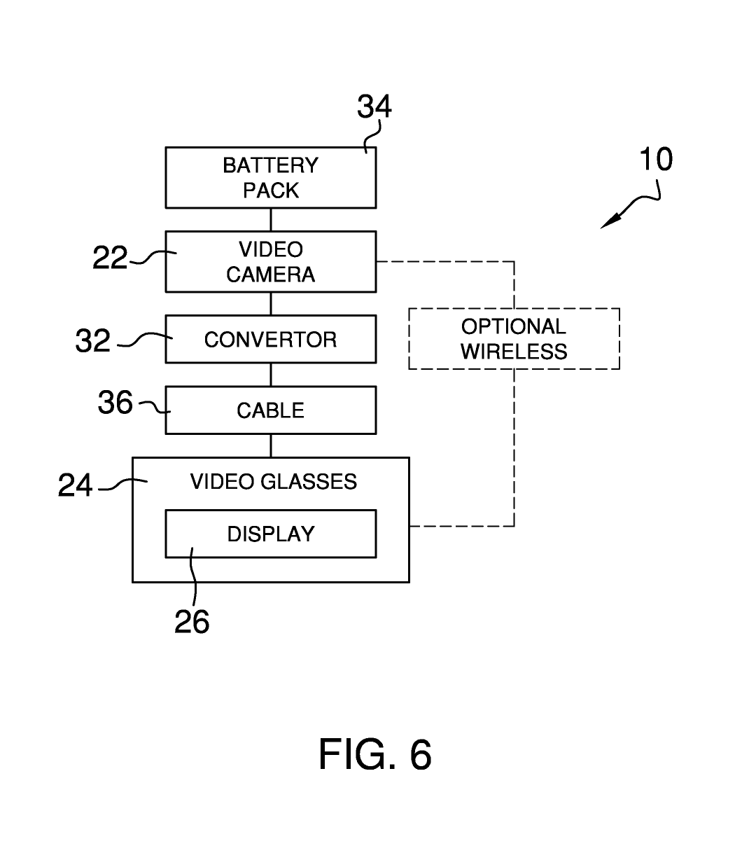

With reference now to the drawings, and in particular FIGS. 1 through 6 thereof, example of the instant head mounted rearview camera system employing the principles and concepts of the present head mounted rearview camera system and generally designated by the reference number 10 will be described.

Referring to FIGS. 1 through 6 a preferred embodiment of the present head mounted rearview camera system 10 is illustrated.

The head mounted rearview camera system 10 includes a headband 20, a reversible field-of-view camera 22 removably mountable to the headband 20, a pair of video glasses 24 in operational communication with the camera 22, and a display 26 integral to the video glasses 24. The display 26 is configured to display images captured by the camera 22 upon the video glasses 24 interior, said images enantiomorphically relayed to the video glasses 24 whereby a user 70 sees a rearward field-of-view oriented relatively with respect to the spatial orientation of the user 70.

An image converter 32 is disposed included with the camera 22, the image converter 32 in operational communication with the camera 22 and the display 26. The image converter 32 renders images captured by the camera 22 enantiomorphically to maintain a correct spatial relationship of said images with respect to the user 70 wearing the device 10. Should images captured by the camera 22 be relayed typically, an object depicted on a user's left side would actually be on a user's right side, and confusion could occur. The image converter 32 therefore maintains the correct spatial relationship of the rearward field-of-view relative a user 70. It should be noted that the image converter 32 is envisioned to be disposed alternately within the camera 22 (the reversible field-of-view camera 22), however, including an image converter 32 as a separate element to the camera 22 enables an embodiment of the device 10 that is useable with an ordinary camera in lieu of a reversible field-of-view camera 22, as desired, in accordance with the intended spirit and scope of the invention.

To power the device, a battery pack 34 is disposed within the headband 20, the battery pack 34 in operational communication with the display 26, the camera 22, and the image converter 32.

In the preferred embodiment illustrated herein, the display 26 is connected to the image converter 32 by a cable 36, however, a wireless configuration is envisioned wherein the display 26 is configured to wirelessly relay images captured by the camera 22 to the video glasses 24.

It should be noted that an embodiment of the present invention is considered wherein the camera 22 is integrated with the pair of video glasses 24 and the headband 20 is obviated thereby, the entire device 10 contained within the pair of video glasses 24. Other means for attaching the camera 22 to the rear of the head are also considered with the use of the word “head band”, such as m for example, a hat, a cap, or other head covering or device wearable upon the head wherein a camera may be successfully integrated.

What is claimed is:

1. A head mounted rearview camera system comprising a reversible field-of-view camera in operational communication with a pair of video glasses wherein images captured by the camera are visible when the video glasses are worn, said images enantiomorphically relayed to the video glasses whereby a user sees a rearward field-of-view oriented relative the spatial orientation of the user.

2. A head mounted rearview camera system comprising:
a headband;
a reversible field-of-view camera removably mountable to the head band;
a pair of video glasses in operational communication with the camera;
a display integral to the video glasses, the display configured to display images captured by the camera upon the video glasses interior;
wherein images captured by the camera are visible when the video glasses are worn, said images enantiomorphically relayed to the video glasses whereby a user sees a rearward field-of-view oriented relative the spatial orientation of the user.

3. The head mounted rearview camera system of claim 1 wherein the video glasses further comprise a pair of lenses disposed connected to the top bar, wherein the display is disposed within at least one of the pair of lenses, said display displaying images captured by the camera onto the interior of at least one of the pair of lenses.

4. The head mounted rearview camera system of claim 3 wherein the camera comprises an image converter in operational communication with the camera and the display, said image converter enantiomorphically rendering images captured by the camera to maintain a correct spatial relationship of said images with respect to the user wearing the device.

5. The head mounted rearview camera system of claim 4 further comprising a battery pack disposed within the headband, said battery pack in operational communication with the display.

6. The battery pack of claim 5 wherein said battery pack is in operational communication with the camera and the image converter.

7. The head mounted rearview camera system of claim 6 wherein the display is connected to the image converter by a cable.

8. The head mounted rearview camera system of claim 6 wherein the display is configured to wirelessly relay images captured by the camera.

9. A head mounted rearview camera system comprising:
a headband;
a reversible field-of-view camera removably mountable to the head band;
a pair of video glasses in operational communication with the camera, the pair of video glasses having a pair of lenses;
a display mounted upon at least one of the pair of lenses, the display configured to display images captured by the camera upon at least one of the pair of lenses interior;
a battery pack disposed within the headband, the battery pack in operational communication with the camera and the display;
wherein images captured by the camera are visible when the video glasses are worn, said images enantiomorphically relayed to the video glasses whereby a user is sensible of a rearward field-of-view oriented consistently with the spatial orientation of the user.

10. The head mounted rearview camera system of claim 9 wherein the display is connected to the image converter by a cable.

11. The head mounted rearview camera system of claim 9 wherein the display is configured to wirelessly display images captured by the camera.
